(19) United States
(12) Patent Application Publication
(10) Pub. No.: US 2016/0046238 A1
(43) Pub. Date: Feb. 18, 2016

(54) Side View Mirror Alignment System

(71) Applicant: Jessie Sallas, Fred, TX (US)

(72) Inventor: Jessie Sallas, Fred, TX (US)

(21) Appl. No.: 14/825,505

(22) Filed: Aug. 13, 2015

Related U.S. Application Data
(60) Provisional application No. 62/036,754, filed on Aug. 13, 2014.

(51) Int. Cl. B60R 1/00; B60R 1/08

(52) U.S. Cl. CPC B60R 1/007; B60R 1/081

(57) ABSTRACT

A side view mirror alignment system is provided. The side view mirror alignment system includes a housing having a laser and a rotation assembly. The housing is removably mounted to an automobile's side view mirror. The alignment system is in communication with the vehicle's transmission or gearbox so as to determine when the vehicle is in reverse. The laser is activated when the automobile is in reverse and is directed to a reflector having a light sensor at the rear of the vehicle. The rotation assembly of the housing is adapted to rotate the side view mirror until the laser aligns with the light sensor on the reflector thereby providing automatically adjusting side view mirrors to improve visibility.

### CROSS REFERENCE TO RELATED APPLICATION

This application claims the benefit of U.S. Provisional Application No. 62/036,754 filed on Aug. 13, 2014. The above identified patent application is herein incorporated by reference in its entirety to provide continuity of disclosure.

### BACKGROUND OF THE INVENTION

### Field of the Invention

The present invention generally relates to mirror alignment systems. More particularly, the present invention relates to a side view mirror alignment system including a housing having a laser and a rotation assembly. The housing is removably mounted to an automobile's side view mirror. The alignment system is in communication with the gearbox or transmission of the vehicle so as to determine when the vehicle is in reverse. The laser is activated when the automobile is in reverse and is directed to a reflector having a light sensor positioned at the rear of the vehicle. The rotation assembly of the housing is adapted to rotate the side view mirror until the laser aligns with the light sensor on the reflector thereby providing improved visibility.

Semi-trailer trucks, SUVs, campers, and other large vehicle or vehicles towing large objects often have problematic blind spots when driving the vehicle in reverse. This makes backing the vehicle up extremely dangerous when the driver does not have a second person to spot for him or her. A driver, however, may not always have access to a person to serve as a spotter for him or her. Therefore, there is a need for an improved blind spot mirror system that is adapted to automatically adjust as the individual drives his or her vehicle in reverse.

Various types of blind spot eliminating devices are known in the prior art. One such device, U.S. Pat. No. 5,235,469, describes a horizontal cut stepped mirror mounted to the pillars of an automobile. Another type of blind spot eliminating device is U.S. Pat. No. 5,479,297 discloses a side view mirror assembly having a fixed mirror and a movable mirror. Further, U.S. Pat. No. 5,666,227 discloses panoramic bi-directional mirrors aimed to the front and to the rear of the driver's field of view. U.S. Pat. No. 5,670,935 discloses image capturing devices used to capture multiple images to the rear of a vehicle and a synthesized view formed from the captured images from the point of view of a single image capture device positioned forward of the vehicle.

The devices in the prior art relate to systems for viewing blind spots, but have various drawbacks. These devices do not comprise a laser and reflector system that is adapted to adjust the positioning of the mirrors. Therefore, there is a need for an improved system for aiding drivers when reversing large vehicles.

### SUMMARY OF THE INVENTION

In view of the foregoing disadvantages inherent in the known types of side view mirror alignment systems now present in the prior art, the present invention provides a new and improved side view mirror alignment system wherein the same can be utilized for providing convenience for the user when driving in reverse.

It is therefore an object of the present invention to provide a new and improved side view mirror alignment system that has all of the advantages of the prior art and none of the disadvantages.

Therefore, it is an object of the present invention to provide a side view mirror alignment system including a housing having a laser and a rotation assembly, wherein the housing is removably mounted to an automobile's side view mirror.

It is yet another object of the present invention to provide a side view mirror alignment system adapted to automatically adjust when the vehicle is in reverse.

It is another object of the present invention to provide a side view mirror alignment system, wherein the laser is activated when the automobile is in reverse and is directed to a reflector in the rear of the vehicle, wherein the laser is in communication with the reflector when the automobile is in reverse.

Another object of the present invention is to provide a side view mirror alignment system including a reflector comprising a light sensor. The rotation assembly of the housing is adapted to rotate the side view mirror until the laser aligns with the light sensor on the reflector thereby providing improved visibility.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a close-up view of the laser housing according to one embodiment of the present invention.

FIGS. 2A and 2B show close-up views of the reflector according to one embodiment of the present invention.

FIG. 3 shows the side view mirror alignment system in use.

FIG. 4 shows a schematic diagram of the side view mirror alignment system according to one embodiment of the present invention.

### DETAILED DESCRIPTION OF THE INVENTION

Reference is made herein to the attached drawings. Like reference numerals are used throughout the drawings to depict like or similar elements of the side view mirror alignment system. For the purposes of presenting a brief and clear description of the present invention, the preferred embodiment will be discussed as used for improving visibility of a side view mirror while reversing a vehicle. The figures are intended for representative purposes only and should not be considered to be limiting in any respect.

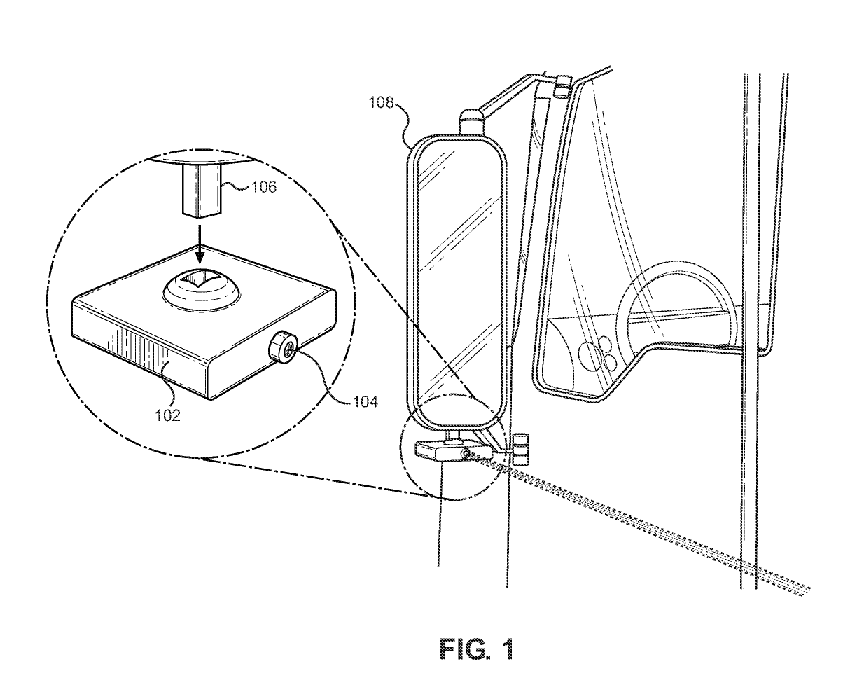

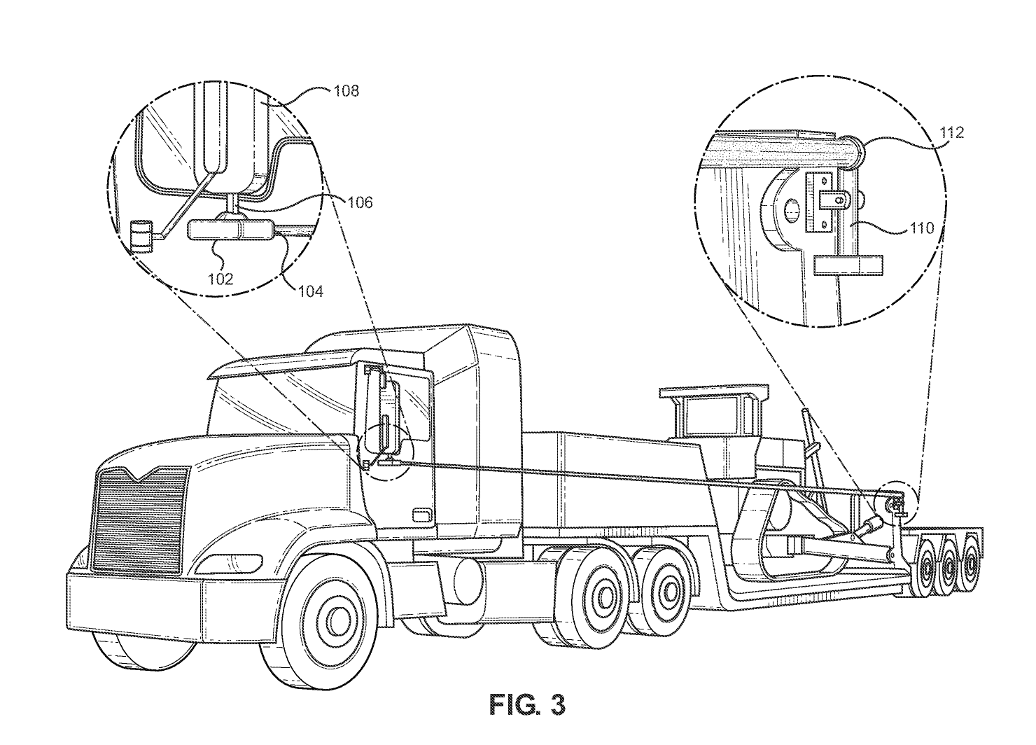

Referring now to FIGS. 1 and 3, there are shown views of the side view mirror alignment system according to one embodiment of the present invention. The side view mirror alignment system includes a housing 102 enclosing a laser 104, and a rotation assembly 106. The rotation assembly 106 is adapted to rotate the side view mirror of the vehicle and the laser 104 so that the side view mirror and laser 104 rotate in conjunction with one another. The housing 102 is adapted to be removably mounted to an automobile's side view mirror 108 or to the door of the vehicle via a bracket and one or more fasteners.

The laser 104 within the housing 102 projects a straight beam towards the rear of the vehicle. A reflector 110 having a light sensor 112 is affixed to the rear of the vehicle and is adapted to receive the beam produced by the laser. Thus, the reflector 110 faces in a forward direction towards the front portion of the vehicle. Preferably, the reflector is positioned so as to be aligned with the laser 104 on the side view mirror of the vehicle. The reflector 110 comprises a mounting bracket for securing the reflector to a portion of the rear of a vehicle using any of various fasteners, such as bolts or magnets, among others. The reflector 110 comprises a light sensor 112 thereon adapted to detect if the laser beam is making contact with the reflector 110. The light sensor 112 is in communication with the rotation assembly. Preferably, the light sensor 112 communicates wirelessly with the rotation assembly via wireless transmitters and wireless receivers.

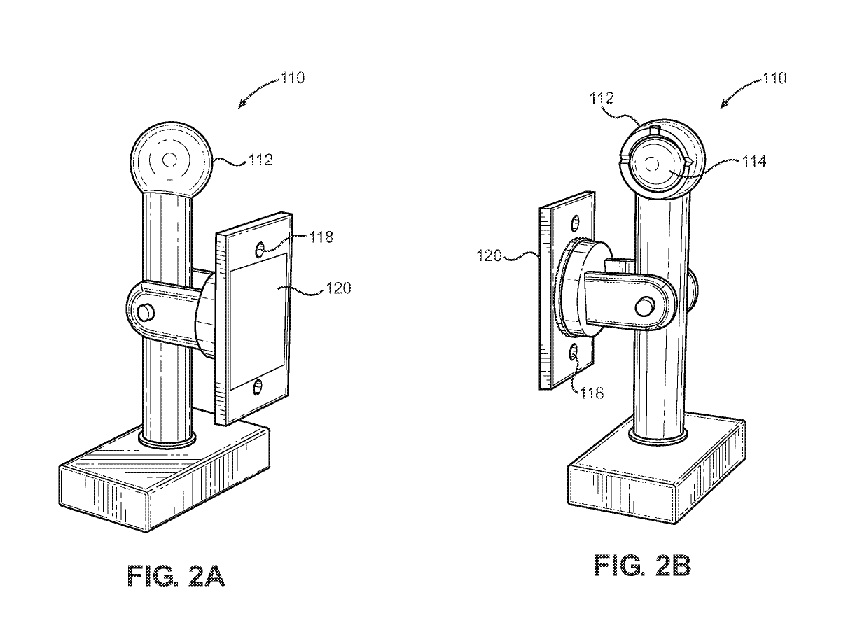

Referring now to FIGS. 2A and 2B, there are shown close-up views of the reflector according to one embodiment of the present invention. The reflector 110 comprises a curved mirror 114 preferably close to, but spaced from, the light sensor 112. More particularly, the curved mirror 114 is adapted to be impinged upon by a portion of the beam produced by the laser. Hence, the beam will impinge simultaneously upon the light sensor 112 and on the curved mirror 114.

The reflector 110 is adapted to be mounted to a rear portion of a large vehicle or to a large object towed by a vehicle via a mounting bracket. The reflector 110 includes a fastener such as a magnet 120 for securing the same to a vehicle. In one embodiment, the mounting bracket of the reflector 110 may include a plurality of apertures 118 that extend through the magnet 120. The apertures 118 are configured to receive a fastener, such as a bolt, therethrough for permanent attachment to the vehicle.

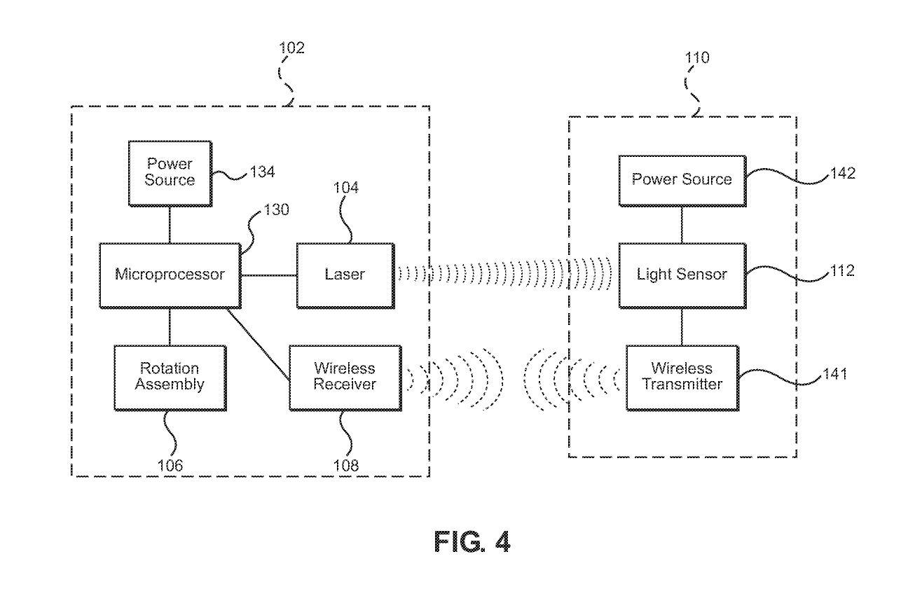

Referring now to FIG. 4, there is shown a schematic diagram of the side view mirror alignment system 100 according to one embodiment of the present invention. The laser housing 102 comprises a control circuit comprising a laser 104, a microprocessor 130, a power source 134, a rotation assembly 106, and a wireless receiver 108.

In operation, the control circuit determines whether the vehicle is placed in reverse. The control circuit is in electrical communication with the gearbox or transmission of a vehicle in order to determine if the vehicle is in reverse. Alternatively, a sensor may be provided for determining if the vehicle is in reverse. Once the vehicle is placed in reverse, the laser 104 automatically activates and produces a beam of light that projects towards the rear of the vehicle. The rotation assembly 106 rotates the side view mirror and also the laser 104 until the laser 104 contacts the reflector positioned at the rear of the vehicle. When the laser 104 contacts the reflector 110, the side view mirror is properly positioned so as to give the driver an improved view of the blind spot of the vehicle. The light sensor 112 detects the beam and transmits a signal to the wireless receiver 108 via a wireless transmitter 141 causing the rotation assembly 106 to stop rotating, and to stop producing a laser beam. In this way, the system automatically adjusts the side view mirrors of a vehicle when the vehicle is placed in reverse.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A side view mirror alignment system, comprising:
a housing comprising a laser and a rotation assembly, wherein the housing is adapted to be removably mounted to a side view mirror of a vehicle so as to rotate said side view mirror and said laser;
a reflector comprising a light sensor, wherein said reflector is adapted to be mounted on a side of a vehicle at a rear portion thereof;
a control circuit comprising a gearbox sensor, wherein said control circuit is adapted to cause said laser to produce a beam of light, wherein said rotation assembly rotates said laser and said side view mirror until said beam of light contacts said light sensor on said reflector so as to automatically adjust said side view mirror when said gearbox determines that said vehicle is in reverse.

2. The side view mirror alignment system of claim 1, wherein said reflector comprises a curved mirror.

3. The side view mirror alignment system of claim 1, wherein the reflector further comprises a mounting bracket that is removably attached to a rear of the automobile.

4. The side view mirror alignment system of claim 3, wherein said reflector further comprises one or more fasteners to secure said reflector to the rear of the vehicle.

5. The side view mirror alignment system of claim 4, wherein said one or more fasteners comprise a magnet.

6. The side view mirror alignment system of claim 1, wherein said laser projects a beam in a rearward direction towards said rear portion of said vehicle.

7. The side view mirror alignment system of claim 1, wherein said reflector is adapted to be positioned such that said light sensor faces towards a front portion of the vehicle.
